(19) United States
(12) Patent Application Publication
(10) Pub. No.: US 2026/0185335 A1
(43) Pub. Date: Jul. 2, 2026

(54) Plastic waterway body of a temperature-regulating faucet

(71) Applicant: Guangdong Weixiang Sanitary Ware Industry Co., Ltd., Kaiping (CN)

(72) Inventor: Weiguang Ruan, Kaiping (CN)

(73) Assignee: Guangdong Weixiang Sanitary Ware Industry Co., Ltd., Kaiping (CN)

(21) Appl. No.: 19/233,291

(22) Filed: Jun. 10, 2025

(30) Foreign Application Priority Data
Dec. 26, 2024 (CN) 202423228524.4

(51) Int. Cl. E03C 1/04; F16K 11/00

(52) U.S. Cl. CPC E03C 1/0403; F16K 19/006

(57) ABSTRACT

The present invention discloses a plastic waterway body of a temperature-regulating faucet, comprising a horizontal tube, both ends of the horizontal tube are connected to a tubular valve seat, the horizontal tube is integrally formed with the tubular valve seat, and the upper end in the middle of horizontal tube is provided with a water outlet end having an upward opening, the inner flow channel of horizontal tube is connected to the inner flow channel of tubular valve seat, and the bottom of tubular valve seat is provided with a downward-extending inlet pipe, the side wall of tubular valve seat is provided with a suction hole, and the inner flow channel of suction hole and of tubular valve seat is connected in the same straight line with the inner flow channel of horizontal tube, and the suction hole cover is provided with a plug. The present invention features a stable structure and low production cost. During injection molding, core extraction can be first performed for the horizontal tube from the suction hole on the side wall of tubular valve seat, and then for the water outlet end and tubular valve seat and finally, a plug is used to seal the suction hole. The process of injection molding has small plastic deformation, smooth internal water circuit, reduced production cost, improved production efficiency, and enhanced overall structural strength and durability.

This application claims priority to Chinese Patent Application 202423228524.4, filed on Dec. 26, 2024, which is incorporated herein by reference.

### TECHNICAL FIELD

The present invention relates to the field of faucet technology, specifically to a plastic waterway body of a temperature-regulating faucet.

### BACKGROUND

Faucets are commonly used bathroom products in people's daily lives. With the improvement of people's living standards, temperature-regulating faucets have become a frequently used faucet. However, traditional temperature-regulating faucets, mainly made of copper casting, incur high costs for producing casting molds, complex casting processes, and cumbersome production processes, resulting in high production costs and hindering mass production. Later, plastic injection molded temperature-regulating faucets emerged. Due to the long water pipeline and injection channel, the high temperature and pressure during injection molding easily lead to large plastic deformation, resulting in poor internal water flow, low injection quality and production capacity, high scrap rate and manufacturing cost, reduced overall structural strength, and poor durability and long-term use effect. Therefore, in order to avoid the shortcomings of existing technologies, it is necessary to make improvements.

### SUMMARY

The purpose of the present invention is to overcome the shortcomings and deficiencies of the prior art and provide a plastic waterway body of a temperature-regulating faucet with stable structure and low production cost.

The present invention is implemented through the following technical solution:

A plastic waterway body of a temperature-regulating faucet, comprising a horizontal tube, both ends of the horizontal tube are connected to a tubular valve seat, the horizontal tube is integrally formed with the tubular valve seat, and the upper end in the middle of horizontal tube is provided with a water outlet end having an upward opening, the inner flow channel of horizontal tube is connected to the inner flow channel of tubular valve seat, and the bottom of tubular valve seat is provided with a downward-extending inlet pipe, the side wall of tubular valve seat is provided with a suction hole, and the inner flow channel of suction hole and of tubular valve seat is connected in the same straight line with the inner flow channel of horizontal tube, and the suction hole cover is provided with a plug.

In further, the plastic waterway body is arranged in an H-shape.

In further the inlet pipe is externally fitted with metal pin.

In further, the metal pins are copper pins.

In further, the plug is externally fitted with an O-ring waterproof rubber ring.

In further, the plug is connected to the tubular valve seat through a latch.

In further, the plug and tubular valve seat are both provided with corresponding latch holes.

In further, the front and rear of the horizontal tube are both externally provided with reinforcing ribs.

In further, the inlet pipe is externally provided with several longitudinal convex strips, and the metal pins are internally provided with grooves corresponding to the convex strips.

In further, the top of tubular valve seat is provided with a valve core locating installation groove.

Compared with prior art, in the present invention, the side wall of tubular valve seat is provided with a suction hole, and the inner flow channel of suction hole and of tubular valve seat is connected in the same straight line with the inner flow channel of horizontal tube, and the suction hole cover is provided with a plug, making the structure of plastic waterway body simple; during injection molding, core extraction can be first performed for the horizontal tube from the suction hole on the side wall of tubular valve seat, and then for the water outlet end and tubular valve seat and finally, a plug is used to seal the suction hole; the process of injection molding has small plastic deformation, smooth internal water circuit, reduced production cost, improved production efficiency, enhanced overall structural strength and durability, and ideal long-term application performance.

### BRIEF DESCRIPTION OF DRAWINGS

In order to more clearly illustrate the technical solution of the embodiments of the present invention, a brief introduction will be given to the accompanying drawings required for the description of the embodiments. Obviously, the accompanying drawings described below are some embodiments of the present invention. Those of ordinary skill in the art can obtain other drawings based on these drawings without creative work.

FIG. 1 is a structural diagram of the plastic waterway body with a temperature-regulating faucet of the present invention;

FIG. 2 is a structural exploded view of the plastic waterway body with a temperature-regulating faucet of the present invention;

FIG. 3 is a schematic diagram of the longitudinal sectional structure of the plastic waterway body of a temperature-regulating faucet of the present invention.

Where: 1—Horizontal tube; 2—Tubular valve seat; 3—Water outlet end; 4—Inlet pipe; 5—Suction hole; 6—Plug; 7—Metal pin; 8—O-shaped waterproof rubber ring; 9—Latch; 10—Latch hole; 11—Reinforcing rib; 12—Convex strip; 13—Valve core locating installation groove.

### DETAILED DESCRIPTION OF EMBODIMENTS

The technical solutions in the embodiments of the present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

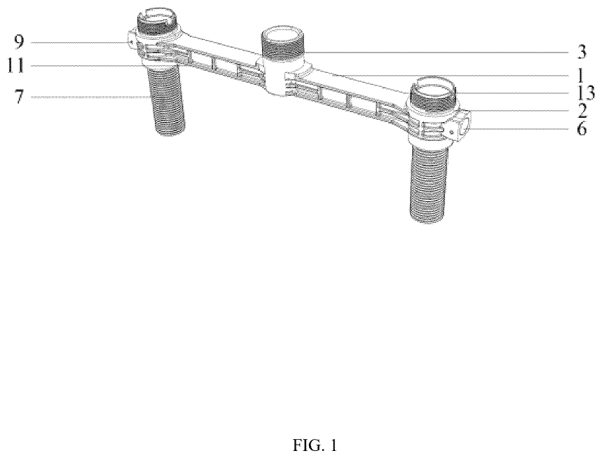

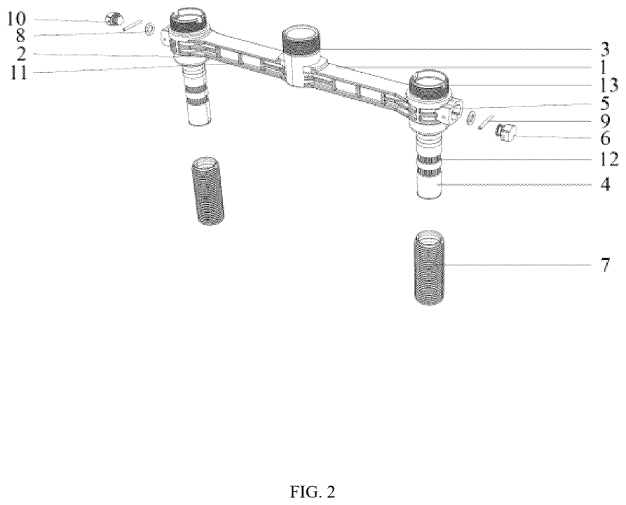

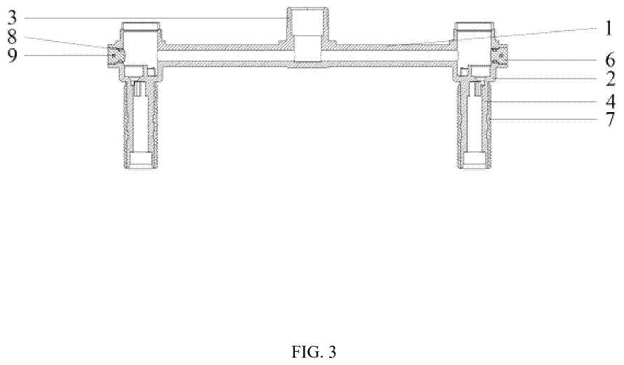

As shown in FIG. 1-3, a plastic waterway body of a temperature-regulating faucet provided by the present invention comprises a horizontal tube 1, both ends of the horizontal tube are connected to a tubular valve seat 2, the horizontal tube 1 is integrally formed with the tubular valve seat 2, and the upper end in the middle of horizontal tube 1 is provided with a water outlet end 3 having an upward opening, the inner flow channel of horizontal tube 1 is connected to the inner flow channel of tubular valve seat 2, and the bottom of tubular valve seat 2 is provided with a downward-extending inlet pipe 4, the side wall of tubular valve seat 2 is provided with a suction hole 5, and the inner flow channel of suction hole 5 and tubular valve seat 2 is connected in the same straight line with the inner flow channel of horizontal tube 1, and the suction hole 5 cover is provided with a plug 6. making the structure of plastic waterway body simple; during injection molding, core extraction can be first performed for the horizontal tube 1 from the suction hole 5 on the side wall of tubular valve seat 2, and then for the water outlet end 3 and tubular valve seat 2 and finally, a plug 6 is used to seal the suction hole 5; the process of injection molding has small plastic deformation, smooth internal water circuit, reduced production cost, improved production efficiency, enhanced overall structural strength and durability, and ideal long-term application performance.

As a specific implementation method, the plastic waterway body is arranged in an H-shape, characterized by simple structure, easy injection molding, high structural strength, and good durability.

The inlet pipe 4 is externally fitted with metal pins 7, facilitating the installation and water inlet connection of plastic waterway body.

As a specific embodiment, the metal pins 7 are durable and sturdy copper pins that are firmly integrated with the plastic waterway body during injection molding.

The plug 6 is externally fitted with an O-ring waterproof rubber ring 8, improving the waterproof sealing performance of the installed plug 6.

The plug 6 is connected to the tubular valve seat through a latch 9, so that the plug 6 is installed more stably to prevent loosening or coming out due to high water pressure.

The plug 6 and tubular valve seat 2 are both provided with corresponding latch holes 10 to facilitate the locating installation of latch 9.

The front and rear of the horizontal tube 1 are both externally provided with reinforcing ribs 11 to enhance the structural strength of plastic waterway body.

The inlet pipe 4 is externally provided with several longitudinal convex strips 12, and the metal pins 7 are internally provided with grooves corresponding to the convex strips 12, so that the combination of metal pins 7 and inlet pipe 4 is more stable, preventing metal pins 7 from rotating during installation.

The top of tubular valve seat 2 is provided with a valve core locating installation groove 13 to facilitate the locating installation of valve core.

Only preferred embodiments of the present invention are described above and it is not intended to limit the present invention. Any modifications, equivalent substitutions, and improvements made within the spirit and principles of the present invention should be included in the scope of protection of the present invention.

What is claimed is:

1. A plastic waterway body of a temperature-regulating faucet, comprising a horizontal tube, both ends of the horizontal tube are connected to a tubular valve seat, the horizontal tube is integrally formed with the tubular valve seat, and the upper end in the middle of horizontal tube is provided with a water outlet end having an upward opening, the inner flow channel of horizontal tube is connected to the inner flow channel of tubular valve seat, and the bottom of tubular valve seat is provided with a downward-extending inlet pipe, the side wall of tubular valve seat is provided with a suction hole, and the inner flow channel of suction hole and of tubular valve seat is connected in the same straight line with the inner flow channel of horizontal tube, and the suction hole cover is provided with a plug.

2. The plastic waterway body of a temperature-regulating faucet according to claim 1, wherein the plastic waterway body is arranged in an H-shape.

3. The plastic waterway body of a temperature-regulating faucet according to claim 1, wherein the inlet pipe is externally fitted with metal pin.

4. The plastic waterway body of a temperature-regulating faucet according to claim 3, wherein the metal pins are copper pins.

5. The plastic waterway body of a temperature-regulating faucet according to claim 1, wherein the plug is externally fitted with an O-ring waterproof rubber ring.

6. The plastic waterway body of a temperature-regulating faucet according to claim 1, wherein the plug is connected to the tubular valve seat through a latch.

7. The plastic waterway body of a temperature-regulating faucet according to claim 6, wherein the plug and tubular valve seat are both provided with corresponding latch holes.

8. The plastic waterway body of a temperature-regulating faucet according to claim 1, wherein the front and rear of the horizontal tube are both externally provided with reinforcing ribs.

9. The plastic waterway body of a temperature-regulating faucet according to claim 3, wherein the inlet pipe is externally provided with several longitudinal convex strips, and the metal pins are internally provided with grooves corresponding to the convex strips.

10. The plastic waterway body of a temperature-regulating faucet according to claim 1, wherein the top of tubular valve seat is provided with a valve core locating installation groove.
